(19) United States
(12) Patent Application Publication
(10) Pub. No.: US 2011/0102682 A1
(43) Pub. Date: May 5, 2011

(54) PROTECTING METHOD AND ELECTRONIC DEVICE USING THE SAME

(75) Inventor: LUNG DAI, Tu-Cheng (TW)

(73) Assignee: HON HAI PRECISION INDUSTRY CO., LTD., Tu-Cheng (TW)

(21) Appl. No.: 12/760,410

(22) Filed: Apr. 14, 2010

(30) Foreign Application Priority Data
Oct. 30, 2009 (CN) 200910309099.2

(51) Int. Cl. H04N 5/63

(52) U.S. Cl. 348/730; 348/E05.127

(57) ABSTRACT

A protecting method includes: detecting whether a user continuously using an electronic device reaches a first predetermined time; and if the time of the user continuously using the electronic device reaches the first predetermined time, disabling display functions of the electronic device.

### BACKGROUND

1. Technical Field

The present disclosure relates to electronic devices, and particularly to a method, for protecting people's health, used by electronic devices.

2. Description of Related Art

People often like to view television after work to relieve their work pressure. However, people may not notice how long they view television because they are engrossed in the television programs. Therefore, if people often view television too long, though their work pressure is relieved, their eyes may get strained because of viewing the television too long.

Therefore, improved protecting methods and electronic devices using the protecting methods are desired.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device in accordance with an exemplary embodiment.

FIG. 2 is a flow chart of a protecting method in accordance with an exemplary embodiment.

### DETAILED DESCRIPTION

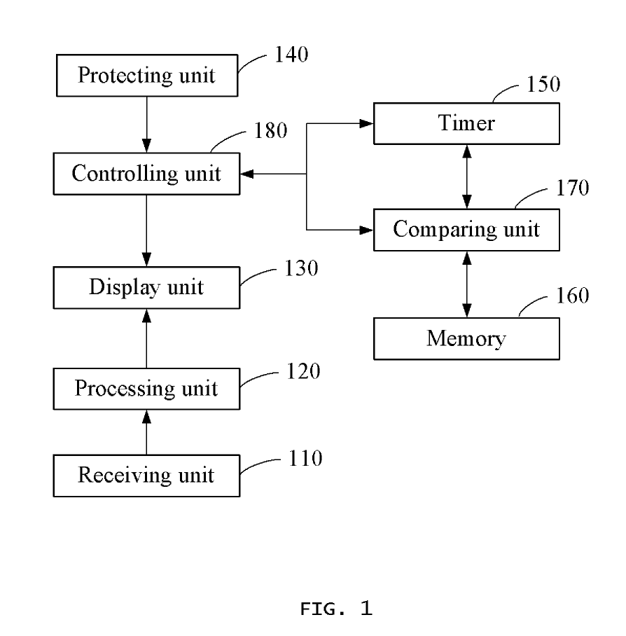

Referring to FIG. 1, an electronic device 100 includes a receiving unit 110, a processing unit 120, a display unit 130, a protecting unit 140, a timer 150, a memory 160, a comparing unit 170, and a controlling unit 180. The electronic device 100 may be a television, a computer, or a video game player.

The receiving unit 110 is used for receiving external data. If the electronic device 100 is a television, the receiving unit 110 may be an antenna for receiving broadcast television signals, or interfaces electrically connected to an optical disc player for receiving the data from the optical disc player. If the electronic device 100 is a computer, the receiving unit 110 may be a network interface.

The processing unit 120 is used for transforming internal data and the external data received by the receiving unit 110 into a format for the display unit 130 displaying, and transmitting the transformed data to the display unit 130 so that the display unit 130 displays the transformed data for the user.

The protecting unit 140 is used for receiving a user's operation and generating an operating signal according to the user's operation. The protecting unit may be a key arranged on the electronic device 100 or a menu item displayed by the electronic device 100. In the embodiment, the electronic device 100 may be a television. The key may be arranged on the television or a remote control of the television.

The memory 160 is used for storing a first predetermined time and a second predetermined time. The first and second predetermined time can be defined by the user according to requirements of the user; or can be defined by the manufacturer before the electronic device leaves the factory. In the embodiment, the first predetermined time is 2 hours, and the second predetermined time is 5 minutes.

The controlling unit 180 is used for responding to the operating signal to enable the timer 150 and the comparing unit 170. The timer 150 is used for computing a first time the user continuously uses the electronic device 100. The comparing unit 170 is used for comparing the first time with the first predetermined time, and generating a first comparing signal when the first time reaches the first predetermined time.

The controlling unit 180 is also used for responding the first comparing signal to disable the display functions of the display unit 130, and enable the timer 150 and the comparing unit 170. Therefore, the user can have a rest, thus their eyestrain is relieved, and harm to the health of the user is eased.

The timer 150 is also used for computing a second time of the display function of the display unit 130 being disabled. The comparing unit 170 is also used for comparing the second time with the second predetermined time, and generating a second comparing signal when the second time reaches the second predetermined time.

The controlling unit 180 is also used for responding to the second comparing signal to enable the display functions of the display unit 130, so that the user can continue to use the electronic device 100.

It is understood that the display functions can be enabled manually when the display functions of the electronic device 100 is disabled. For example, the electronic device 100 may have a key, the display functions can be enabled by a user pressing the key.

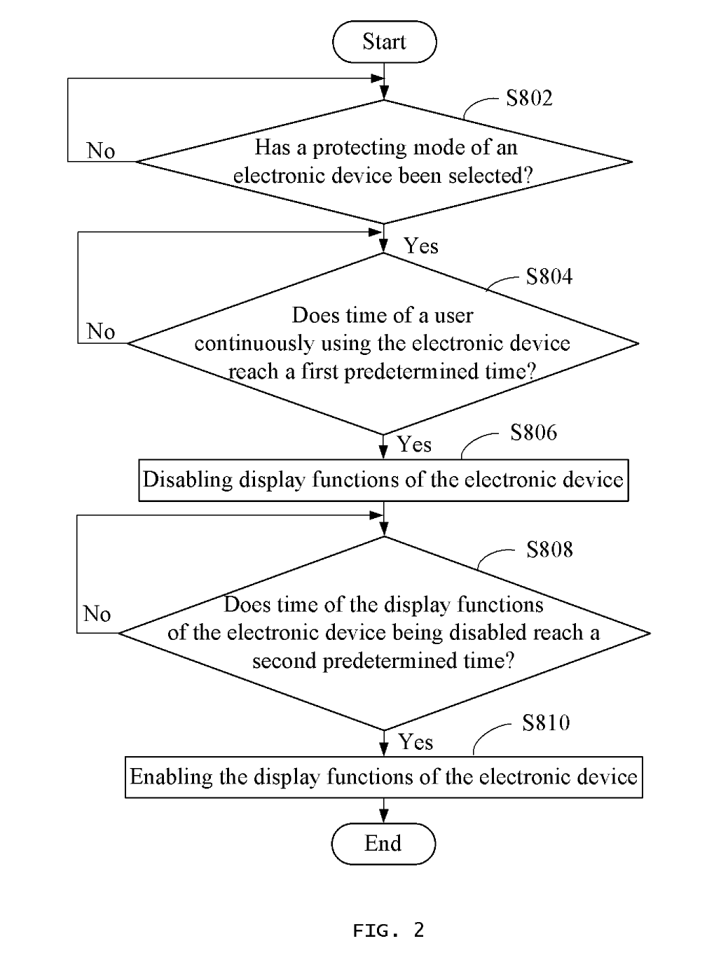

Referring to FIG. 2, a protecting method is used for an electronic device, such as a television, a computer, or a video game player, having display functions. The method can protect user's health by preventing users from using the electronic device too long. The protecting method includes the following steps.

In step S802, determining whether a protecting mode of the electronic device has been selected. If the protecting mode of the electronic device has been selected by a user, step S804 is implemented. If the protecting mode of the electronic device has not been selected by the user, step S802 is implemented again. The user can select the protecting mode by pressing a key or selecting a menu item. In the embodiment, the electronic device may be a television. The key is arranged on the television or a remote control of the television.

In step S804, detecting whether continuous usage of the electronic device reaches a first predetermined time. If the continuous usage time reaches the first predetermined time, step S806 is implemented. If the continuous usage time does not reach the first predetermined time, step S804 is implemented again. The first predetermined time can be defined by the user according to requirements of the user; or can be defined by the manufacturer before the electronic device leaves the factory. In the embodiment, the first predetermined time is 2 hours.

In step S806, disabling the display functions of the electronic device. The user can have a rest, thus their eyestrain is relieved, and harm to the health of the user is eased.

In step S808, detecting whether time of the display functions of the electronic device being disabled reaches the second predetermined time. If the time of the display functions of the electronic device being disabled reaches the second predetermined time, step S810 is implemented. If the time of the display functions of the electronic device being disabled does not reach the second predetermined time, step S808 is implemented again. The second predetermined time can be defined by the user according to requirements of the user; or can be defined by the manufacturer before the electronic device leaves the factory. In the embodiment, the second predetermined time is 5 minutes.

In step S810, enabling the display functions of the electronic device, thus the user can continue to use the electronic device.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A protecting method used by an electronic device, the protecting method comprising:
detecting whether continuous usage of the electronic device reaches a first predetermined time; and
if the continuous usage time reaches the first predetermined time, disabling display functions of the electronic device.

2. The protecting method according to claim 1, further comprising:
if the continuous usage time does not reach the first predetermined time, the step of detecting whether continuous usage of the electronic device reaches the first predetermined time is implemented.

3. The protecting method according to claim 1, further comprising:
detecting whether time of the display functions of the electronic device being disabled reaches a second predetermined time; and
if the time of the display functions of the electronic device being disabled reaches the second predetermined time, enabling the display functions of the electronic device.

4. The protecting method according to claim 3, further comprising:
if the time of the display functions of the electronic device being disabled does not reach the second predetermined time, the step of detecting whether the time of the display functions of the electronic device being disabled reaches the second predetermined time is implemented.

5. The protecting method according to claim 1, further comprising:
determining whether a protecting mode of the electronic device has been selected; and
if the protecting mode of the electronic device has been selected, the step of detecting whether the continuous usage time reaches the first predetermined time is implemented.

6. The protecting method according to claim 5, further comprising:
if the protecting mode of the electronic device has not been selected, the step of determining whether the protecting mode of the electronic device has been selected is implemented.

7. An electronic device, comprising:
a display unit having display functions;
a memory storing a first predetermined time;
a protecting unit responding to a user's operation and generating an operating signal according to the user's operation;
a timer;
a controlling unit responding to the operating signal to enable the timer for computing a first time being a time the user continuously using the electronic device; and
a comparing unit comparing the first time with the first predetermined time, and generating a first comparing signal when the first time reaches the first predetermined time;
wherein the controlling unit also responds to the first comparing signal to disable the display functions of the display unit.

8. The electronic device according to claim 7, wherein the memory is also configured to store a second predetermined time, the controlling unit responds to the first comparing signal to enable the timer and the comparing unit; the timer also computes a second time being a length of time of the display functions of the display unit being disabled; the comparing unit compares the second time with the second predetermined time, and generates a second comparing signal when the second time reaches the second predetermined time; the controlling unit responds to the second comparing signal to enable the display functions of the display unit.

9. The electronic device according to claim 7, wherein the protecting unit is one of a key disposed on the electronic device and a menu item displayed by the display unit.

10. The electronic device according to claim 9, wherein the electronic device is a television, the protecting unit is the key disposed on one of the television and a remote control of the television.

11. An electronic device, comprising:
a displaying unit having display function; and
a controlling unit adapted to disable the display functions of the display unit according to a first time of a user continuously using the electronic device.

12. The electronic device according to claim 11, further comprising a timer for computing the first time.

13. The electronic device according to claim 12, further comprising:
a memory for storing a first predetermined time; and
a comparing unit adapted to compare the first time with the first predetermined time, and generate a first comparing signal when the first time reaches the first predetermined time, the controlling unit further adapted to disable display functions of the display unit responding to the first comparing signal.

14. The electronic device according to claim 11, wherein the controlling unit is further adapted to enable the display functions of the display unit according to a second time of the display unit being disabled.

15. The electronic device according to claim 14, further comprising a timer for computing the second time.

16. The electronic device according to claim 15, further comprising:
a memory for storing a second predetermined time; and
a comparing unit adapted to compare the second time with the second predetermined time, and generate a second comparing signal when the second time reaches the second predetermined time, the controlling unit further adapted to enable the display functions of the display unit responding to the second comparing signal.
